(19) United States
(12) Patent Application Publication
(10) Pub. No.: US 2008/0088636 A1
(43) Pub. Date: Apr. 17, 2008

(54) System and method for the display and control of virtual environments in a single pipe graphics memory controller hub using picture-in-picture

(76) Inventor: Nee Shen Ho, Penang (MY)

Correspondence Address: INTEL CORPORATION;c/o INTELLEVATE, LLC, P.O. BOX 52050, MINNEAPOLIS, MN, 55402, US

(21) Appl. No.: 11/581,098

(22) Filed: Oct. 13, 2006

(51) Int. Cl. G06T 1/60

(52) U.S. Cl. 345/530

(57) ABSTRACT

A system and method for the display and control of virtual environments in a single pipe graphics memory controller hub using picture-in-picture. The system has a first virtual machine to render on a primary framebuffer, where the primary framebuffer has a picture-in-picture. The system also has a second virtual machine to render on a fake framebuffer. The operating system of the first virtual machine is different from the operating system of the second virtual machine. The system also has a driver. The driver to pass an offset address to an interface abstraction layer of the second virtual machine, where the offset address is to the beginning of the picture-in-picture. The driver to scale down the output of the fake framebuffer such that its contents will fit into the picture-in-picture and the driver to transfer the scaled down output onto the primary framebuffer at the offset address. By using hardware interrupts from a keyboard or mouse, control can switch between the primary and secondary systems (e.g., first and second virtual machines). Other embodiments are described and claimed.

### BACKGROUND

Graphics memory controlling hubs provide digital and analog video display support for display devices such as Cathode Ray Tube (CRT) Monitors, Low Voltage Differential Signal (LVDS) Displays, Digital Visual Interface (DVI) and television sets. With the introduction of virtualization technology (VT), we are now able to run different virtual environments on a single system. These virtual environments may involve two or more different operating systems, where each of the different operating systems may be utilizing a graphics memory controlling hub to provide video display support for the same display device. As such, when running different virtual environments, the system requires a different graphic adaptor/card for each of the different virtual environments without physically plugging/unplugging the display device. This hardware configuration is expensive and is not well suited for a small form factor.

### BRIEF DESCRIPTION OF THE DRAWINGS

FIG. 1 illustrates one embodiment of a system.

FIG. 2 illustrates one embodiment of a system.

FIG. 3 illustrates one embodiment of a system.

FIG. 4 illustrates one embodiment of a logic flow.

FIG. 5 illustrates one embodiment of a logic flow.

FIG. 6 illustrates one embodiment of a device.

### DETAILED DESCRIPTION

Various embodiments of the invention may be generally directed to a system and method for the display and control of virtual environments in a single pipe graphics memory controller hub using picture-in-picture. Pipes are semiconductor logic that adjusts the timing clock of the display output from the native clock to suit the timings of the display devices. Implementing the invention via a virtualized platform provides the ability for two or more different operating systems to utilize a single pipe graphics memory controller hub to provide digital or analog video display support for the same display device without requiring a different graphic adaptor/card for each of the different virtual environments. This hardware configuration is well suited for a small form factor.

In an embodiment, the operating system of a first virtual machine does all of its rendering on a primary framebuffer. The operating system of a second virtual machine does all of its rendering on a fake framebuffer. The operating system of the second virtual machine assumes it is rending onto the primary framebuffer. The driver of the secondary operating system passes an offset address in the fake framebuffer to the interface abstraction layer of the second virtual machine. This offset address is to the beginning of the picture-in-picture in the primary framebuffer. The driver scales down the output of the fake framebuffer such that its contents will fit into the picture-in-picture. In an embodiment, the scaling down of the fake framebuffer may be done using 3D instructions in the Intel® BLEND module of the driver. The final scaled down output is transferred onto the primary framebuffer at the offset address (beginning of the picture-in-picture) that was previously passed to the interface abstraction of the second virtual machine. Thus, via the use of picture-in-picture technology, the two different environments of the first virtual machine and the second virtual machine may be monitored and displayed using a single display adaptor. Other embodiments may be described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

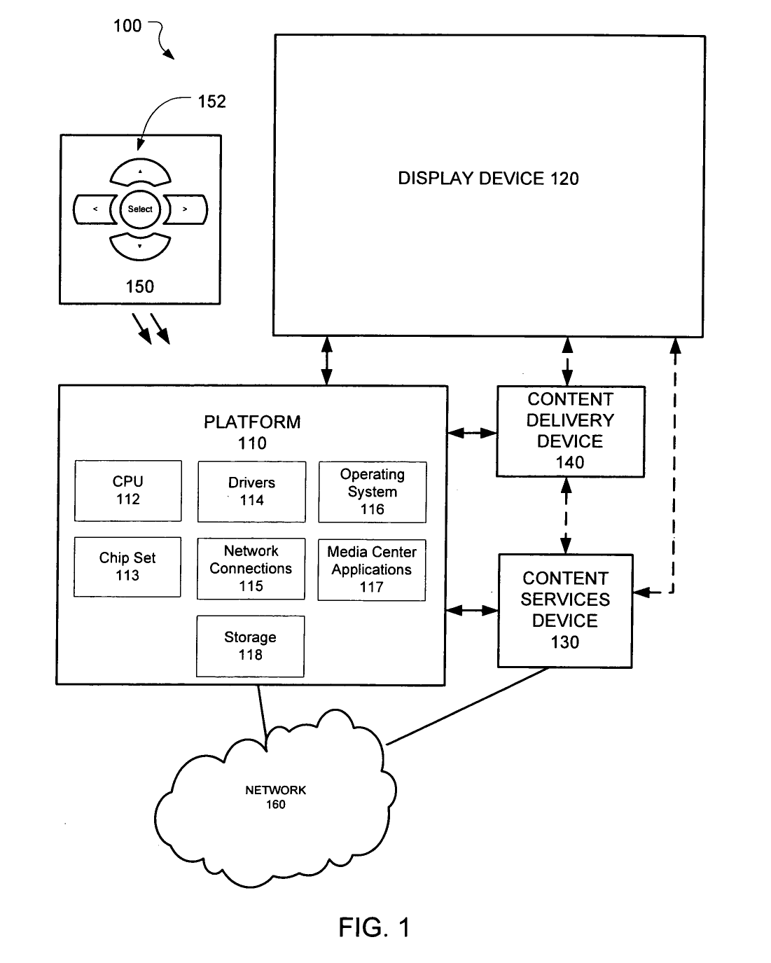

FIG. 1 illustrates one embodiment of a system 100, in which some embodiments of the invention may operate. In one embodiment, system 100 may be a digital home entertainment system although system 100 is not limited in this context. In one embodiment, system 100 comprises a platform 110 coupled to a display device 120. In one embodiment, platform 110 may comprise or may be implemented as a media platform such as the Viiv™ media platform made by Intel® Corporation. In one embodiment, platform 110 may receive content from a content device such as a content services device 130 or a content delivery device 140 or other similar content source. In an embodiment, content services device 130 may be hosted by any national, international and/or independent service and thus accessible to platform 110 via the Internet. A content services device 130 may be coupled to platform 110 and/or to display device 120. Platform 110 and/or content services device 130 may be coupled to a network 160 to communicate (e.g., send and/or receive) media information to and from network 160. A content delivery device 140 also may be coupled to platform 110 and/or to display device 120. In various embodiments, platform 110 and content services device 130 may be integrated, or platform 110 and content delivery device 140 may integrated, or platform 110, content services device 130, and content delivery device 140 may be integrated, for example. In various embodiments, platform 110 and display device 120 may be an integrated unit and display device, or content services device 130 may be integrated, or display device 120 and content delivery device 140 may integrated.

A navigation controller 150 comprising one or more navigation buttons 152 may be used to interact with either platform 110 or display device 120, and/or both, for example. In one embodiment, navigation buttons 152 comprise an upward navigation button, a downward navigation button, a leftward navigation button, and a rightward navigation button. Navigation buttons 152 also may comprise a select button to execute a particular function.

Navigation controller 150 may be a pointing device. The pointing device may be any computer hardware component (specifically human interface device) that allows a user to input spatial (i.e., continuous and multi-dimensional) data into a computer. Many systems such as computer aided design (CAD), graphical user interfaces (GUI), and televisions and monitors allow the user to control and provide data to the computer or television using physical gestures—point, click, and drag—typically by moving wired or wireless pointing device such as a mouse, trackball, touchpad, pointing stick, light pen, joystick, head pointer, eye tracking device, digitizing tablet, data glove, remote controller, among others. Movements of the pointing device are echoed on a display device (such as display device 120) by movements of a pointer, cursor, focus ring, or other visual indicators displayed on the display device.

The pointing device may be a conventional remote control unit used to interact with audio/visual devices such as televisions, monitors, cable boxes, digital video disc (DVD) player, compact disc (CD) players, digital video recorders (DVR), video games, digital video camera, and/or digital still camera, among others, for example. The pointing device may be a wireless remote that operates on wireless principles employing infra-red (IR) energy or radio frequency (RF) energy. In other embodiments, the pointing device may be hard wired to the display device, for example.

In one embodiment, platform 110 may comprise a CPU 112, a chip set 113, one or more drivers 114, one or more network connections 115, an operating system 116, and/or a media center application 117 comprising one or more software applications, for example. Platform 110 also may comprise storage 118.

In one embodiment, CPU 112 may comprise one or more processors such as dual-core processors. Examples of dual-core processors include the Pentium® D processor and the Pentium® processor Extreme Edition both made by Intel® Corporation, which may be referred to as the Intel Core Duo processors, for example.

In one embodiment, chip set 113 may comprise any one of or all of the Intel® 945 Express Chipset family, the Intel® 955X Express Chipset, Intel® 975X Express Chipset family, plus ICH7-DH or ICH7-MDH controller hubs, which all are made by Intel® Corporation.

In one embodiment, drivers 114 may comprise the Quick Resume Technology Drivers made by Intel® to enable users to instantly turn on and off platform 110 like a television with the touch of a button after initial boot-up, when enabled, for example. In addition, chip set 113 may comprise hardware and/or software support for 5.1 surround sound audio and/or high definition 7.1 surround sound audio, for example. Drivers 114 may include a graphics driver for integrated graphics platforms. In one embodiment, the graphics driver may comprise a peripheral component interconnect (PCI) Express graphics card.

In one embodiment, network connections 115 may comprise the PRO/1000 PM or PRO/100 VE/VM network connection, both made by Intel® Corporation.

In one embodiment, operating system 116 may comprise the Windows® XP Media Center made by Microsoft® Corporation. In one embodiment, one or more media center applications 117 may comprise a media shell to enable users to interact with content using navigation controller 150 (e.g., remote control) from a distance of about 10-feet away from platform 110 or display device 120, for example. In one embodiment, the media shell may be referred to as a “10-feet user interface,” for example. In addition, one or more media center applications 117 may comprise the Quick Resume Technology made by Intel®, which allows instant on/off functionality and may allow platform 110 to stream content to media adaptors or other content services devices 130 or content delivery devices 140 when the platform is turned “off.”

In one embodiment, storage 118 may comprise the Matrix Storage technology made by Intel® to increase the storage performance enhanced protection for valuable digital media when multiple hard drives are included, for example.

In one embodiment, display device 120 may comprise any television type monitor or display. Display device 120 may comprise, for example, a computer display screen, video monitor, television-like device, and/or a television. Display device 120 may be digital and/or analog.

In various embodiments, content services device 130 may comprise a cable television box, personal computer, network, telephone, Internet enabled devices or appliance capable of delivering digital information and/or content, and any other similar device capable of unidirectionally or bidirectionally communicating content between content providers and platform 110 and/display device 120, via network 160. It will be appreciated that the content may be communicated unidirectionally and/or bidirectionally to and from any one of the components in system 100 and a content provider via network 160. Examples of content may include any media information including, for example, video, music, and gaming information. Content services device 130 receives content such as cable television programming including media information, digital information, and/or other content. Examples of content providers may include any cable or satellite television or radio content providers and may include, for example, ESPN, Movielink, and MTV Overdrive for video; Napster, AOL and Tiscali for music; Gametap, Square Enix and T-Online for gaming; and YouTube and Flickr for sharing services.

In various embodiments, content delivery device 140 may comprise a DVD player, CD player, DVR, video game, digital video camera, digital still camera, and/or MP3 (MPEG-1 Audio Layer 3 where MPEG stands for Moving Pictures Experts Group) player, among others, for example.

Platform 110 may receive content from network 160 directly or via content services device 130. Platform 110 may receive content from content delivery device 140. In one embodiment, platform 110 may receive control signals from navigation controller 150.

In various embodiments, system 100 may be implemented as a wireless system, a wired system, or a combination of both. When implemented as a wireless system, system 100 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 100 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 110 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 1.

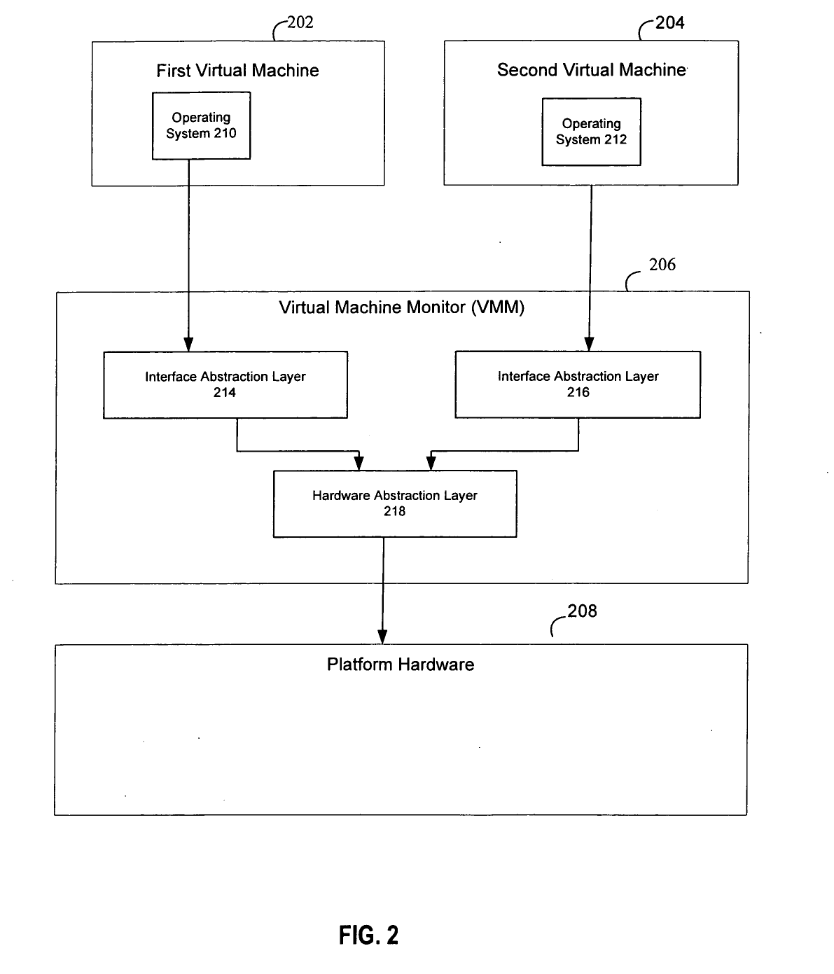

FIG. 2 illustrates an environment for the invention, in which some embodiments may operate. In FIG. 2, the invention is implemented via an embodiment of a virtualized platform. In general, a virtualized platform is a single physical platform that is segregated into a plurality of virtual machines. The physical platform incorporates at least one virtual machine monitor (VMM). A conventional VMM typically runs on a computer and presents to other software the abstraction of one or more virtual machines. Each virtual machine may function as a self-contained platform, running its own “guest operating system” (i.e., an operating system (OS) hosted by the VMM) and other software, collectively referred to as guest software.

Processes running within a virtual machine are provided with an abstraction of some hardware resources and may be unaware of other virtual machines within the system. A hypervisor provides the virtualization abstraction of computer systems underneath it. Every virtual machine assumes that it has full control over the hardware resources allocated to it. The VMM is an entity that is responsible for appropriately managing and arbitrating system resources among the virtual machines including, but not limited to, processors, input/out (I/O) devices and memory.

In the embodiment described herein in relation to FIG. 2, a virtualized platform is utilized for the display and control of virtual environments in a single pipe graphics memory controller hub using picture-in-picture. Implementing the invention via a virtualized platform provides the ability for two or more different operating systems to utilize a single pipe graphics memory controller hub to provide digital or analog video display support for the same display device without requiring a different graphic adaptor/card for each of the different operating systems. This hardware configuration is well suited for a small form factor.

Referring to FIG. 2, the environment includes, but is not necessarily limited to, a first virtual machine 202, a second virtual machine 204, a VMM 206 and platform hardware 208. Though two virtual machines are shown in FIG. 2, it is understood that any number of virtual machines may be present in environment. Each of these components is described next in more detail.

First virtual machine 202 may include, but is not necessarily limited to, an operating system 210. Second virtual machine 204 may include, but is not necessarily limited to, an operating system 212. In an embodiment, operating system 210 may be a Windows® operating system and operating system 212 may be a Linux® operating system, for example. In an embodiment, both operating systems 210 and 212 are running on the same Intel® Embedded Graphics Driver version. This embedded graphics driver version may have a layered architecture, whereby the hardware specific functions and the operating systems interface functions are abstracted. An example embodiment of this layered abstracted architecture is shown in VMM 206.

VMM 206 may include, but is not necessarily limited to, an interface abstraction layer 214, an interface abstraction layer 216 and a hardware abstraction layer 218. Interface abstraction layer 214 handles the callback functions for operating system 210. Interface abstraction layer 216 handles the callback functions for operating system 212. Hardware abstraction layer 218 includes implementation that is hardware specific, such as setting of registers and sending instructions to instructions buffers.

The layered abstracted architecture illustrated in VMM 206 allows for the dynamic linking of hardware abstraction layer 218 to the interface abstraction layer of the driver (e.g., an embedded graphics driver). Here, both interface abstraction layers 214 and 216 can share the same instance of hardware abstraction layer 218 in video memory. Using one instance of hardware abstraction layer 218 allows the driver to schedule the sending of instructions and the setting of registers in platform hardware 208. Thus, the layered abstracted architecture of VMM 206 allows both operating systems 210 and 212 to have an instance of their driver callback functions, and thus allowing both operating systems to continue running at the same time.

Platform hardware 208 can be of a personal computer (PC), digital television, mainframe, handheld device, portable computer, set-top box, or any other computing system, that is adapted to perform the functionality of the invention. In an embodiment of the invention, platform hardware 208 is similar to what was described above with reference to FIG. 1.

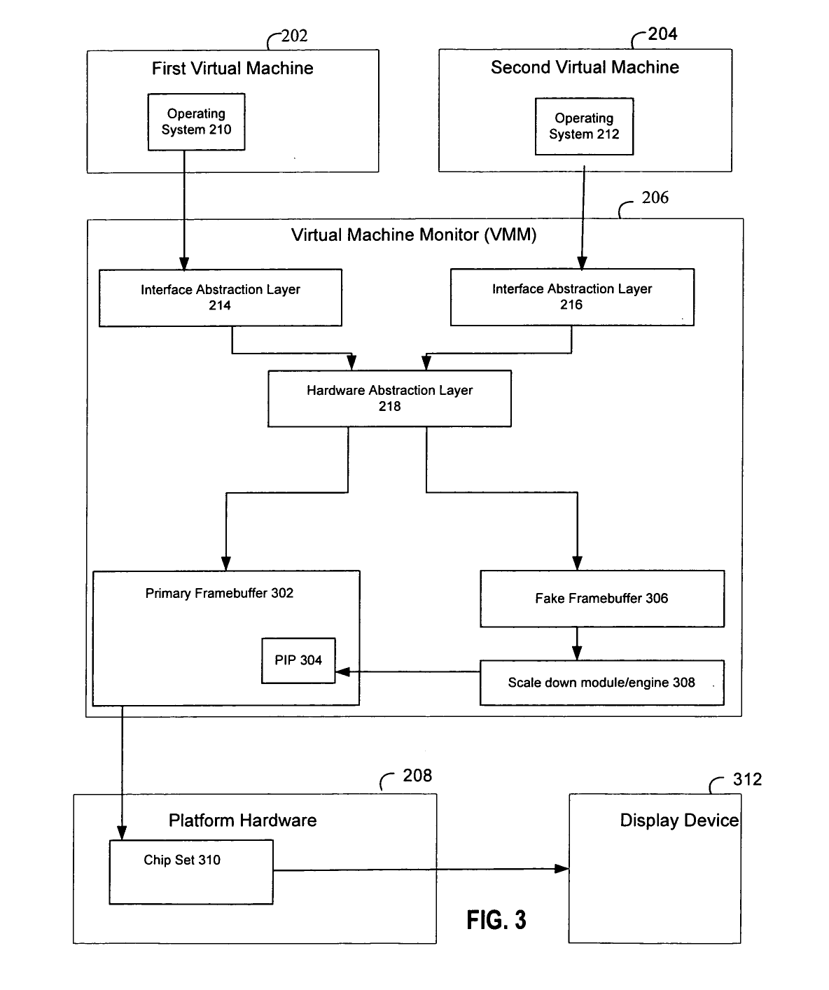

For the two different operating systems 210 and 212 to run at the same time on the same platform hardware 208 and observed at the same time (without requiring two display devices and two independent graphics cards), picture-in-picture technology may be utilized. An embodiment system is illustrated in FIG. 3. Referring to FIG. 3, VMM 206 may include a primary framebuffer 302, a fake framebuffer 306 and a scale down module/engine 308. Primary framebuffer 302 may include a picture-in-picture (PIP) 304. By using picture-in-picture technology, the two different environments of first virtual machine 202 and second virtual machine 204 may be monitored and displayed using a single display adaptor. In an embodiment, the single display adaptor may be a single pipe adaptor. Platform hardware 208 may include a chip set 310. In an embodiment, chip set 310 may comprise any one of or all of the Intel® 945 Express Chipset family, the Intel® 955X Express Chipset, Intel® 975X Express Chipset family, plus ICH7-DH or ICH7-MDH controller hubs, which all are made by Intel® Corporation. Chip set 310 may contain a graphic controller which converts software instructions into digital or analog display signals. These digital or analog display signals may be passed to a display device 312. Display device 312 may be a television set, a CRT monitor, a liquid crystal display, and so forth.

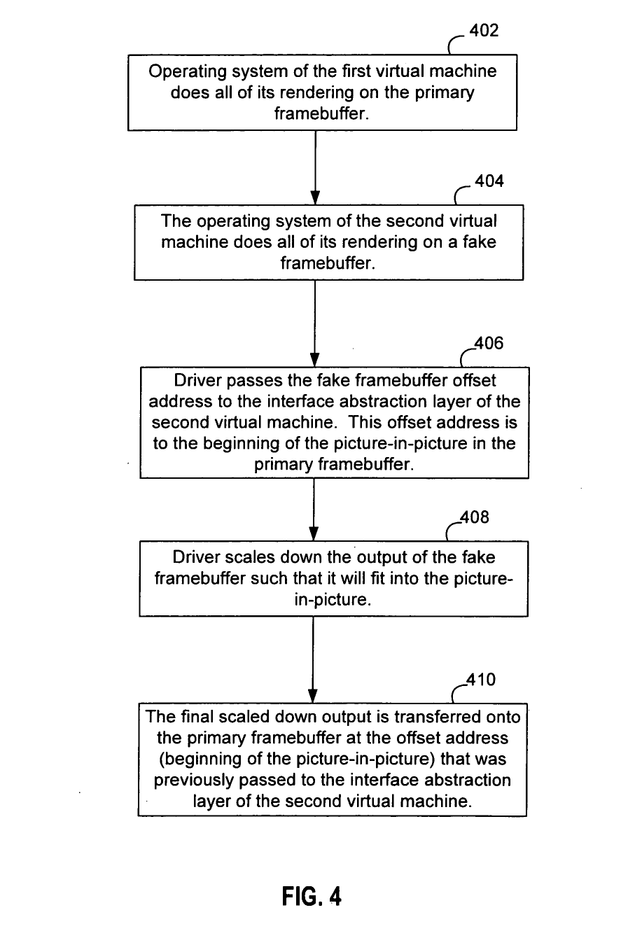

The operation of FIG. 3 is described next with reference to FIG. 4.

Operations for the above embodiments may be further described with reference to the following figure and accompanying examples. Although such figure presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof.

FIG. 4 illustrates one embodiment of a logic flow 400. The logic flow 400 may be representative of the operations executed by one or more embodiments described herein, for example, the operations executed by system 100. In one embodiment, logic flow 400 may be representative of the operations executed by a processor (e.g., the CPU 112) under the control of one more software applications (e.g., media center applications 117). Platform 110 comprising processor 112 provides the necessary information to display device 120. The embodiments of the invention, however, are not limited to the elements or in the context shown or described in FIG. 4.

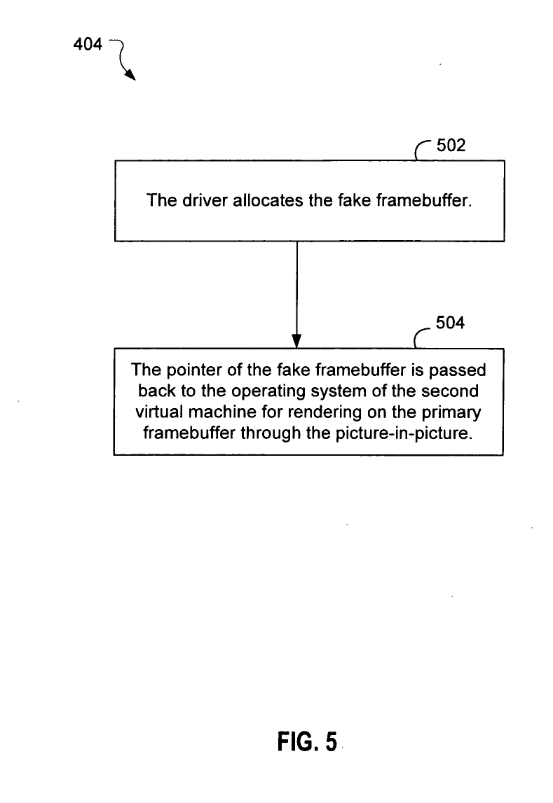

As shown in logic flow 400, the operating system of the first virtual machine (such as operating system 210 of first virtual machine 202 of FIGS. 2 and 3) does all of its rendering on a primary framebuffer (such as primary framebuffer 302 of FIG. 3), at block 402. At block 404, the operating system of the second virtual machine (such as operating system 212 of second virtual machine 204 of FIGS. 2 and 3) does all of its rendering on a fake framebuffer (such as fake framebuffer 306 of FIG. 3). The operating system of the second virtual machine assumes it is rending onto the primary framebuffer. Additional detail for this step is shown in FIG. 5. Referring to FIG. 5, the driver allocates the fake framebuffer, at block 502. At block 504, the pointer of the fake frame framebuffer is passed back to the operating system of the second virtual machine for rendering on the primary framebuffer through the picture-in-picture.

Referring back to FIG. 4 and block 406, the driver passes the fake framebuffer offset address to the interface abstraction layer of the second virtual machine (such as interface abstraction layer 214 of FIGS. 2 and 3). This offset address is to the beginning of the picture-in-picture in the primary framebuffer (such as PIP 304 of FIG. 3).

At block 408, the driver scales down the output of the fake framebuffer such that its contents will fit into the picture-in-picture. Here, in an embodiment, the driver may utilize a scale down module/engine (such as module/engine 308 of FIG. 3) such as the Intel® BLEND module/engine.

At block 410, the final scaled down output is transferred onto the primary framebuffer at the offset address (beginning of the picture-in-picture) that was previously passed to the interface abstraction of the second virtual machine.

In an embodiment, an application may be included in the VMM (such as VMM 206 of FIGS. 2 and 3) that detects a pre-programmed hotkey or mouse action to signal a switch of which operating system will render to the primary framebuffer and which will render to the fake frame buffer. This application may send custom instructions into the driver to switch the environment. During the set mode, the primary framebuffer's pointer will be passed to the second operating system and vice versa. In an embodiment, by using hardware interrupts from a keyboard or mouse, control can switch between the primary and secondary systems (e.g., first and second virtual machines). Thus, via the use of picture-in-picture technology, the two different environments of the first virtual machine and the second virtual machine may be monitored and displayed using a single display adaptor.

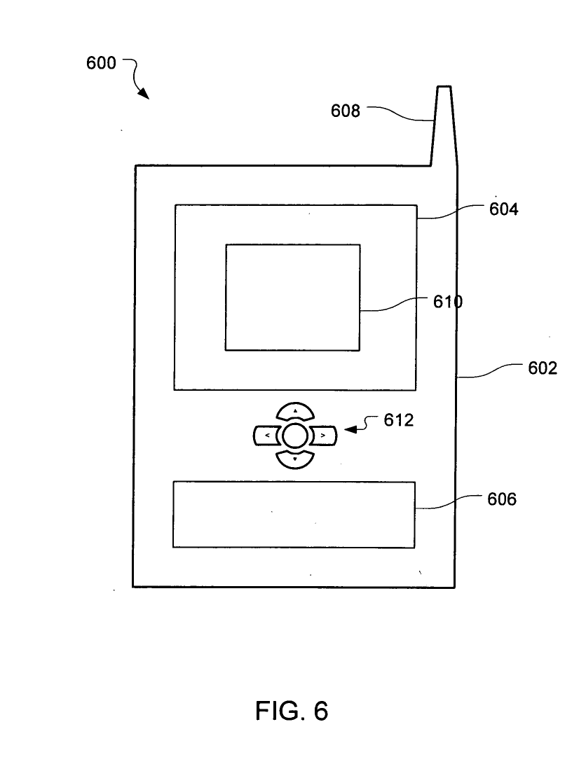

FIG. 6 illustrates one embodiment of a device 600. In one embodiment, for example, device 600 may comprise a communication system. In various embodiments, device 600 may comprise a processing system, computing system, mobile computing system, mobile computing device, mobile wireless device, computer, computer platform, computer system, computer sub-system, server, workstation, terminal, personal computer (PC), laptop computer, ultra-laptop computer, portable computer, handheld computer, personal digital assistant (PDA), cellular telephone, combination cellular telephone/PDA, smart phone, pager, one-way pager, two-way pager, messaging device, and so forth. The embodiments are not limited in this context.

In one embodiment, device 600 may be implemented as part of a wired communication system, a wireless communication system, or a combination of both. In one embodiment, for example, device 600 may be implemented as a mobile computing device having wireless capabilities. A mobile computing device may refer to any device having a processing system and a mobile power source or supply, such as one or more batteries, for example. Examples of a mobile computing device may include a laptop computer, ultra-laptop computer, portable computer, handheld computer, palmtop computer, personal digital assistant (PDA), cellular telephone, combination cellular telephone/PDA, smart phone, pager, one-way pager, two-way pager, messaging device, data communication device, and so forth. Examples of a mobile computing device also may include computers that are arranged to be worn by a person, such as a wrist computer, finger computer, ring computer, eyeglass computer, belt-clip computer, armband computer, shoe computers, clothing computers, and other wearable computers. In one embodiment, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 6, device 600 may comprise a housing 602, a display 604, an input/output (I/O) device 606, and an antenna 608. Device 600 also may comprise a five-way navigation button 612. I/O device 606 may comprise a suitable keyboard, a microphone, and/or a speaker, for example. Display 604 may comprise any suitable display unit for displaying information appropriate for a mobile computing device. I/O device 606 may comprise any suitable I/O device for entering information into a mobile computing device. Examples for I/O device 606 may include an alphanumeric keyboard, a numeric keypad, a touch pad, input keys, buttons, switches, rocker switches, voice recognition device and software, and so forth. Information also may be entered into device 600 by way of microphone. Such information may be digitized by a voice recognition device. Device 600 may comprise a user interface 610 that may be displayed on display 604. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
rendering on a primary framebuffer by a first virtual machine, wherein the primary framebuffer has a picture-in-picture;
rendering on a fake framebuffer by a second virtual machine, wherein an operating system of the first virtual machine is different from an operating system of the second virtual machine and wherein the first and second virtual machines exist on the same platform;
passing an offset address, by a driver, to an interface abstraction layer of the second virtual machine, wherein the offset address is to the beginning of the picture-in-picture;
scaling down, by the driver, output of the fake framebuffer such that its contents will fit into the picture-in-picture; and
transferring, by the driver, the scaled down output onto the primary framebuffer at the offset address.

2. The method of claim 1, wherein rendering on a fake framebuffer by a second virtual machine comprises:
allocating, by the driver, the fake framebuffer; and
passing, by the driver, a pointer to the fake framebuffer to the interface abstraction layer of the second virtual machine for rendering on the primary framebuffer through the picture-in-picture.

3. The method of claim 1, wherein the scaling down is done via a BLEND module.

4. The method of claim 1, wherein both the operating system of the first virtual machine and the operating system of the second virtual machine are running on the same embedded graphics driver version.

5. The method of claim 4, wherein the embedded graphics driver version has a layered architecture that includes abstracted hardware specific functions and abstracted operating systems interface functions.

6. The method of claim 1, wherein the platform is one of a personal computer (PC), a digital television, a handheld device, a portable computer and a set-top box.

7. A system, comprising:
a first virtual machine to render on a primary framebuffer, wherein the primary framebuffer has a picture-in-picture;
a second virtual machine to render on a fake framebuffer, wherein an operating system of the first virtual machine is different from an operating system of the second virtual machine; and
a driver, wherein the driver to pass an offset address to an interface abstraction layer of the second virtual machine, wherein the offset address is to the beginning of the picture-in-picture, wherein the driver to scale down output of the fake framebuffer such that its contents will fit into the picture-in-picture, and wherein the driver to transfer the scaled down output onto the primary framebuffer at the offset address.

8. The system of claim 7, wherein the driver to allocate the fake framebuffer and to pass a pointer to the fake framebuffer to the interface abstraction layer of the second virtual machine for rendering on the primary framebuffer through the picture-in-picture.

9. The system of claim 7, wherein the scaling down is done via a BLEND module.

10. The system of claim 7, wherein both the operating system of the first virtual machine and the operating system of the second virtual machine are running on the same embedded graphics driver version.

11. The system of claim 10, wherein the embedded graphics driver version has a layered architecture that includes abstracted hardware specific functions and abstracted operating systems interface functions.

12. A machine-readable medium containing instructions which, when executed by a processing system, cause the processing system to perform a method, the method comprising:
rendering on a primary framebuffer by a first virtual machine, wherein the primary framebuffer has a picture-in-picture;
rendering on a fake framebuffer by a second virtual machine, wherein an operating system of the first virtual machine is different from an operating system of the second virtual machine and wherein the first and second virtual machines exist on the same platform;
passing an offset address, by a driver, to an interface abstraction layer of the second virtual machine, wherein the offset address is to the beginning of the picture-in-picture;
scaling down, by the driver, output of the fake framebuffer such that its contents will fit into the picture-in-picture; and
transferring, by the driver, the scaled down output onto the primary framebuffer at the offset address.

13. The machine-readable medium of claim 12, wherein rendering on a fake framebuffer by a second virtual machine comprises:
allocating, by the driver, the fake framebuffer; and
passing, by the driver, a pointer to the fake framebuffer to the interface abstraction layer of the second virtual machine for rendering on the primary framebuffer through the picture-in-picture.

14. The machine-readable medium of claim 12, wherein the scaling down is done via a BLEND module.

15. The machine-readable medium of claim 12, wherein both the operating system of the first virtual machine and the operating system of the second virtual machine are running on the same embedded graphics driver version.

16. The machine-readable medium of claim 15, wherein the embedded graphics driver version has a layered architecture that includes abstracted hardware specific functions and abstracted operating systems interface functions.

17. The machine-readable medium of claim 12, wherein the platform is one of a personal computer (PC), a digital television, a handheld device, a portable computer and a set-top box.
